(19) United States
(12) Patent Application Publication
(10) Pub. No.: US 2026/0242297 A1
(43) Pub. Date: Aug. 20, 2026

(54) METHOD FOR PREPARING SPHERICAL ALUMINUM NITRIDE POWDER WITH HIGH FLOWABILITY

(71) Applicant: National Chung Shan Institute of Science and Technology, Taoyuan (TW)

(72) Inventors: Jian-long Ruan, Taoyuan (TW); Cheng-hung Shih, Taoyuan (TW)

(21) Appl. No.: 18/988,742

(22) Filed: Dec. 19, 2024

(51) Int. Cl. C04B 35/626; C04B 35/581; C04B 35/63; C04B 35/634

(52) U.S. Cl. CPC C04B 35/62695; C04B 35/581; C04B 35/6261; C04B 35/6264; C04B 35/62655; C04B 35/6303; C04B 35/6342; C04B 2235/3217; C04B 2235/3225; C04B 2235/77; C04B 2235/94; C04B 2235/95

(57) ABSTRACT

A method for preparing spherical aluminum nitride powder with high flowability is provided and involves: (A) mixing aluminum nitride powder, a sintering aid, a dispersant, and a solvent through wet ball milling; (B) adding a binder and organic alcohol-based additive to form a mixed slurry via a second wet ball milling process; (C) atomizing the slurry into droplets; (D) drying the droplets to produce spherical granules; and (E) collecting granules with D₅₀ of 60-90 μm, bulk density of 0.8-1.1 g/cm³, and an angle of repose <30°.

### BACKGROUND

### Technical Field

The present invention relates to a method for preparing spherical aluminum nitride powder, particularly to a method for producing spherical aluminum nitride powder with high flowability using a centrifugal spray drying apparatus.

### Description of Related Art

Aluminum nitride (AlN) is an advanced electronic ceramic material that has gained significant attention due to its excellent thermal conductivity and electrical insulation properties. It is recognized as one of the most prominent high-performance materials. Its unique physical properties include high thermal conductivity, high electrical resistivity, low dielectric constant, low thermal expansion coefficient, superior heat resistance, excellent mechanical strength, high chemical stability, and non-toxicity. These characteristics make it suitable for various applications, such as electronic ceramic substrates, electronic component packaging materials, corrosion-resistant components, and high-thermal-conductivity additives.

Aluminum nitride (AlN) belongs to the hexagonal crystal system with a wurtzite structure. Its atoms are bonded by strong covalent bonds in a tetrahedral arrangement, resulting in a high melting point and excellent thermal conductivity. It is one of the few non-metallic solids with high thermal conductivity. The theoretical density of AlN is 3.26 g/cm³. This high thermal conductivity is attributed to its compliance with the following principles: (1) low atomic weight, (2) strong atomic bonding, (3) simple crystal structure, and (4) high lattice vibration harmonicity. The theoretical thermal conductivity of AlN reaches up to 320 W/mK, while commercial AlN products typically exhibit a thermal conductivity ranging from 170 to 230 W/mK. High-purity AlN is colorless and exhibits transparency; however, its properties are highly susceptible to variations in chemical purity and density. Due to AlN's strong affinity for oxygen, some oxygen atoms are incorporated into the AlN lattice during processing, forming impurity defects that degrade its thermal conductivity. This reduction of thermal conductivity occurs because the presence of lattice defects, such as impurities, scatters phonons, thereby significantly lowering thermal conductivity. Furthermore, AlN with poor densification exhibits reduced thermal conductivity coefficients.

The sintering preparation of densified aluminum nitride ceramics has been a key focus of research. As a covalent-bonded material, aluminum nitride is challenging to sinter in the solid phase. Therefore, low-melting-point sintering aids must be added to facilitate densification during high-temperature sintering by forming a molten liquid phase as a medium. Currently, aluminum nitride ceramic substrates are primarily produced using the doctor blade forming method, which is suitable for thin-sheet materials. However, this method is not applicable for aluminum nitride ceramic structural components with a thickness exceeding 5 mm, which require alternative preparation methods such as dry-pressing. The dry-pressing process imposes stricter requirements on the characteristics of the powder, including morphology, particle size distribution, flowability, and bulk density. Consequently, it is necessary to develop granulation techniques for aluminum nitride powder to produce spherical aluminum nitride powder with high flowability and an appropriate particle size distribution.

In the current production processes for aluminum nitride ceramic granulated powder, defects exist in the solid-liquid ratio of the slurry. When the solid content of the slurry increases, the viscosity rises, resulting in larger droplet diameters during rotary atomization. The centrifugal kinetic energy is insufficient to transform the ejected droplets into complete spherical shapes, often resulting in elongated or fragmented irregular forms, which are unfavorable for spray granulation. Additionally, improper setting of the inlet and outlet temperatures of the drying tower exacerbates the issue. If the inlet and outlet temperatures are set too low, the droplets may not dry completely, causing granulated powder to agglomerate. Conversely, if the inlet and outlet temperatures are set too high, the droplet surface dries too quickly, forming a hard shell that hinders normal shrinkage of the droplets. This results in hollow or concave irregular granulated powder.

In the current production processes for aluminum nitride ceramic granulated powder, the solid content and viscosity of the slurry significantly influence the morphology and sphericity of the dried particles. Therefore, the proportions of binders, dispersants, additives, and solvents in the slurry must be appropriately adjusted to optimize the aluminum nitride slurry formulation. Improperly setting the inlet and outlet temperatures of the drying tower, whether too low or too high, can lead to excessively slow or rapid droplet drying rates, resulting in agglomeration of granulated powder or the formation of hollow and concave granulated particles.

### SUMMARY

To address the aforementioned issues, the applicant of the present invention provides a method for preparing spherical aluminum nitride powder with high flowability. This method features an optimized aluminum nitride slurry formulation and spray drying process parameters. Additionally, by incorporating organic alcohols with high surface tension, the method enhances the sphericity and flowability of the resulting granulated powder, thereby improving the yield and overall performance of aluminum nitride ceramic blocks fabricated using dry pressing and high-temperature sintering methods.

The aspect of the present invention is to provide a method for preparing aluminum nitride ceramic granulated powder. By optimizing the slurry formulation and centrifugal spray drying process, the method addresses the issues of the prior art, resulting in a spherical aluminum nitride powder with high flowability.

A method for preparing spherical aluminum nitride powder with high flowability is provided. The method comprises the following steps. (A) Aluminum nitride powder, a sintering aid, a dispersant, and a solvent are provided and mixed through a first wet ball milling process according to a first fixed weight ratio to produce a mixture. (B) A binder and an organic alcohol-based additive are added to the mixture obtained in step (A) according to a second fixed weight ratio, and the resulting composition undergoes a second wet ball milling process to form a mixed slurry. (C) The mixed slurry is atomized into droplets. (D) The atomized mixed slurry is dried to produce dried spherical aluminum nitride granules. (E) The dried spherical aluminum nitride granules are collected to obtain spherical aluminum nitride powder with high flowability, characterized by an average particle size distribution D₅₀ of 60-90 μm, a bulk density of 0.8-1.1 g/cm³, and an angle of repose of less than 30°.

The present invention provides a method for preparing spherical aluminum nitride powder with high flowability, which in another embodiment includes the following steps: (A) Aluminum nitride powder, a sintering aid, a dispersant, and a solvent are provided and mixed in a ball mill according to a first fixed weight ratio to undergo a first wet ball milling process. (B) A binder and an additive are provided, added to the ball mill from step (A) according to a second fixed weight ratio, and a second wet ball milling process is performed to form a mixed slurry with a certain viscosity. (C) The mixed slurry is fed at a fixed rate onto the atomizer disk of a spray dryer for droplet atomization. (D) Under high-speed rotation of the atomizer disk, the mixed slurry is dispersed into fine droplets by centrifugal force and enters a drying tower with controlled inlet and outlet temperatures, where the organic solvent in the droplets evaporates, resulting in dried spherical aluminum nitride granules. (E) The dried spherical aluminum nitride granules fall into the collection bucket at the bottom of the drying tower for collection, resulting in spherical aluminum nitride powder with high flowability, characterized by an average particle size distribution D₅₀ of 60-90 μm, a bulk density of 0.8-1.1 g/cm³, and an angle of repose of less than 30°.

In an embodiment of this invention, wherein the aluminum nitride powder in step (A) has a purity of over 99%, an oxygen content of <1.0 wt %, and an average particle size of 1-5 μm; the sintering aid is a rare earth metal compound, or an alkaline earth metal compound, which is selected from one of yttrium oxide, yttrium fluoride, magnesium oxide, calcium oxide, and calcium fluoride; the dispersant is selected from one of citric acid, fish oil, polyethyleneimine, triethyl phosphate, polyacrylic acid, and sodium stearate; and the solvent is an organic solvent selected from one of anhydrous ethanol, methanol, isopropanol, ethyl acetate, methyl ethyl ketone, and n-butanol.

In another embodiment of this invention, the first fixed weight ratio in step (A) is 29-45 wt % of the aluminum nitride powder, 1-5 wt % of the sintering aid, and 50-70 wt % of the solvent, with 0.1-3 wt % of the dispersant calculated based on the weight of the aluminum nitride powder.

In yet another embodiment of this invention, the first wet ball milling process in step (A) is performed for a time of 1-20 hours.

In yet another embodiment of this invention, the binder in step (B) is selected from the group consisting of polyvinyl butyral resin, acrylic resin, and phenolic resin; and the additive is an organic alcohol selected from the group consisting of ethylene glycol, cyclopentanol, and cyclohexanol.

In yet another embodiment of this invention, the second fixed weight ratio in step (B) is 1-10 wt % of the binder and 3-20 wt % of the additive, calculated based on the weight of the aluminum nitride powder.

In yet another embodiment of this invention, the second wet ball milling process in step (B) is performed for a time of 20-72 hours.

In yet another embodiment of this invention, the viscosity of the mixed slurry in step (B) is 100-3000 cP.

In yet another embodiment of this invention, steps (C) to (E) are performed using a centrifugal spray drying apparatus, and the centrifugal spray drying apparatus comprises a feeding unit, an atomizer disc, a drying tower, and a collection bucket.

In yet another embodiment of this invention, the fixed feeding rate of the mixed slurry in step (C) is 3-10 kg/hr.

In yet another embodiment of this invention, the rotation speed of the atomizer disk in step (D) is 5,000-10,000 rpm; the inlet temperature of the drying tower is 90-120° C.; and the outlet temperature of the drying tower is 60-90° C.

The above summary, along with the detailed description and accompanying drawings, serves to further explain the methods, means, and effects employed by the present invention to achieve the intended objectives. Additional objectives and advantages of the invention will be elaborated in the subsequent description and illustrations.

### BRIEF DESCRIPTION OF THE DRAWINGS

FIG. 1 is a process flowchart illustrating a method for preparing spherical aluminum nitride powder with high flowability according to an embodiment of the present invention.

FIG. 2 is an optical microscope (OM) image (200×) of aluminum nitride granulated powder prepared using ethylene glycol as an additive in an embodiment of the present invention.

FIG. 3 is a scanning electron microscope (SEM) image (3000×) of aluminum nitride granulated powder prepared using ethylene glycol as an additive in an embodiment of the present invention.

FIG. 4 is an optical microscope (OM) image (200×) of aluminum nitride granulated powder prepared using cyclohexanol as an additive in another embodiment of the present invention.

FIG. 5 is a scanning electron microscope (SEM) image (2000×) of aluminum nitride granulated powder prepared using cyclohexanol as an additive in another embodiment of the present invention.

FIG. 6 is an optical microscope (OM) image (200×) of aluminum nitride granulated powder obtained after spray drying a slurry with excessively high viscosity.

### DETAILED DESCRIPTION

The following provides specific examples to illustrate the embodiments of the present invention. Those skilled in the art will readily appreciate the advantages and effects of the present invention based on the disclosures in this specification.

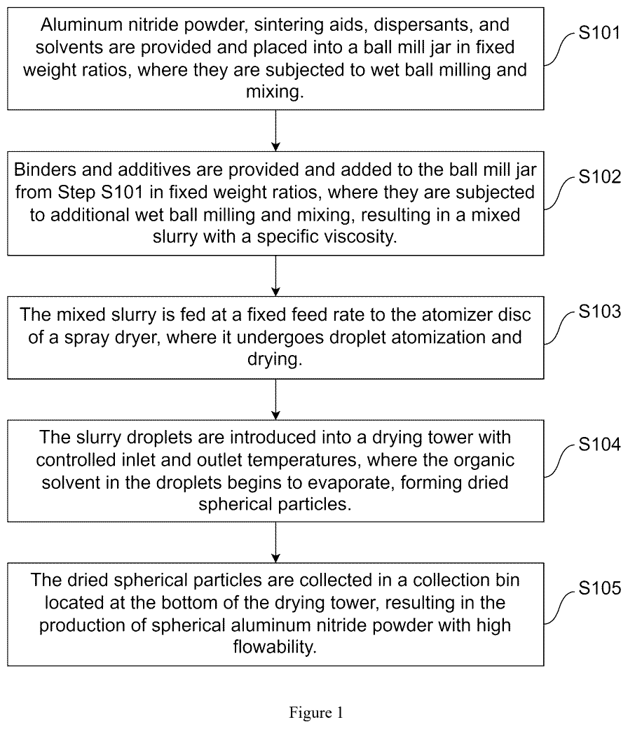

Please refer to FIG. 1, which illustrates a process flowchart of a method for preparing spherical aluminum nitride powder with high flowability according to an embodiment of the present invention. The steps comprise:

Step S101: Aluminum nitride powder, sintering aids, dispersants, and solvents are provided and placed into a ball mill jar in fixed weight ratios, where they are subjected to wet ball milling and mixing.

Step S102: Binders and additives are provided and added to the ball mill jar from Step S101 in fixed weight ratios, where they are subjected to additional wet ball milling and mixing, resulting in a mixed slurry with a specific viscosity.

Step S103: The mixed slurry is fed at a fixed feed rate to the atomizer disc of a spray dryer, where it undergoes droplet atomization and drying.

Step S104: The slurry droplets are introduced into a drying tower with controlled inlet and outlet temperatures, where the organic solvent in the droplets begins to evaporate, forming dried spherical particles.

Step S105: The dried spherical particles are collected in a collection bucket located at the bottom of the drying tower, resulting in the production of spherical aluminum nitride powder with high flowability.

In the first embodiment of the present invention, the aluminum nitride powder described in Step S101 is preferably of a purity exceeding 99%, with an oxygen content of less than 1.0 wt % and an average particle size ranging from 1 to 5 μm. The sintering aid described in Step S101 is preferably either yttrium oxide or calcium oxide in this embodiment.

In the first embodiment of the present invention, the dispersant described in Step S101 is preferably either fish oil or triethyl phosphate. The solvent described in Step S101 is preferably selected from the group consisting of anhydrous ethanol, ethyl acetate, and n-butanol.

In the first embodiment of the present invention, the fixed weight ratio described in Step S101 is preferably 35-40 wt % of aluminum nitride powder, 3-5 wt % of sintering aid, and 55-62 wt % of solvent. Additionally, the dispersant is calculated based on the weight of the aluminum nitride powder and is preferably 0.1-1 wt %.

In the first embodiment of the present invention, the wet ball milling and mixing time described in Step S101 is preferably 1 to 10 hours (hr).

In the first embodiment of the present invention, the binder described in Step S102 is preferably selected from the group consisting of polyvinyl alcohol butyral resin and acrylic resin. The additive described in Step S102 is preferably either ethylene glycol or cyclohexanol.

In the first embodiment of the present invention, the fixed weight ratio described in Step S102 is preferably 1-5 wt % of binder and 3-10 wt % of additive, based on the weight of the aluminum nitride powder.

In the first embodiment of the present invention, the wet ball milling and mixing time described in Step S102 is preferably 20 to 48 hours (hr).

In the first embodiment of the present invention, the mixed slurry with a specific viscosity described in Step S102 preferably has a viscosity ranging from 100 to 600 cP.

In the first embodiment of the present invention, the fixed feed rate of the mixed slurry described in Step S103 is preferably 3 to 5 kg/hr.

In the first embodiment of the present invention, the atomizer disc rotation speed described in Step S104 is preferably 6,000 to 8,000 rpm. The inlet temperature of the drying tower is preferably 90° C. to 100° C., and the outlet temperature of the drying tower is preferably 60° C. to 75° C.

In the first embodiment of the present invention, the spherical aluminum nitride powder with high flowability obtained in Step S105 has an average particle size distribution (D₅₀) ranging from 60 to 90 μm, a bulk density ranging from 0.8 to 1.1 g/cm³, and an angle of repose of 30° or less.

Through the steps described in the first embodiment of the present invention, an optimized slurry solid content ratio and formulation can be designed to achieve a mixed slurry with appropriate viscosity. By incorporating organic alcohols with high surface tension and controlling the spray drying parameters, including atomizer rotation speed, inlet temperature, and outlet temperature, spherical aluminum nitride powder with the required average particle size distribution and high flowability can be obtained.

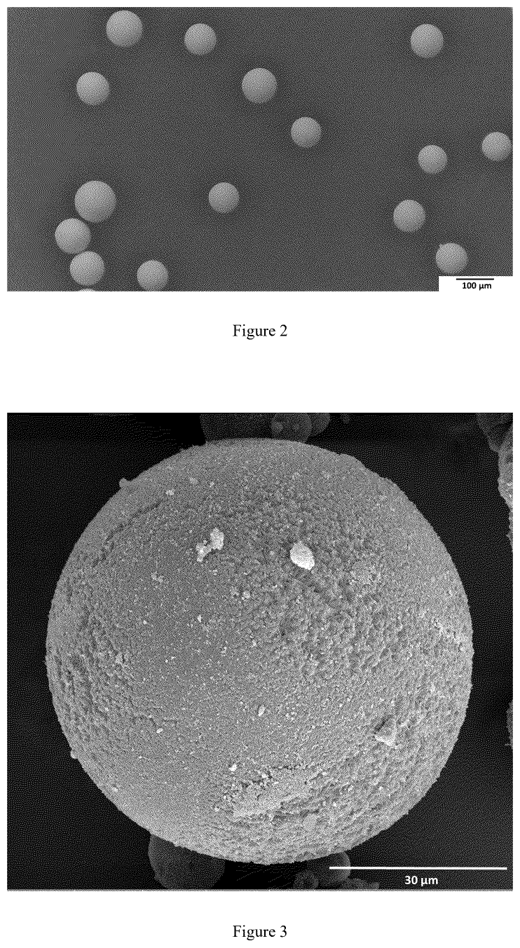

Please refer to FIGS. 2 and 3, which are optical microscope (OM) images (200×) and scanning electron microscope (SEM) images (3000×), respectively, of aluminum nitride granulated powder using ethylene glycol as the additive in an embodiment of the present invention. The solid content of the initial slurry for spray drying was 42 wt %, with the weight percentage composition of the slurry being: 37 wt % aluminum nitride (AlN) powder, 5 wt % yttrium oxide (Y₂O₃) powder, and 58 wt % ethyl acetate. Additionally, 1 wt % polyvinyl butyral (PVB) resin, 1 wt % fish oil, and 4 wt % ethylene glycol were added to the slurry, based on the weight of the aluminum nitride powder. The spray drying process parameters were as follows: a feed rate of 4.7 kg/hr, an atomizer rotation speed of 6,500 rpm, an inlet temperature of 95° C., and an outlet temperature of 70° C. From the 200×OM image in FIG. 2 and the 3000×SEM image in FIG. 3, it can be observed that the spray-dried aluminum nitride granulated powder using ethylene glycol as the additive exhibits a complete spherical morphology. The particle size of an individual granule observed in the SEM image is approximately 70 μm.

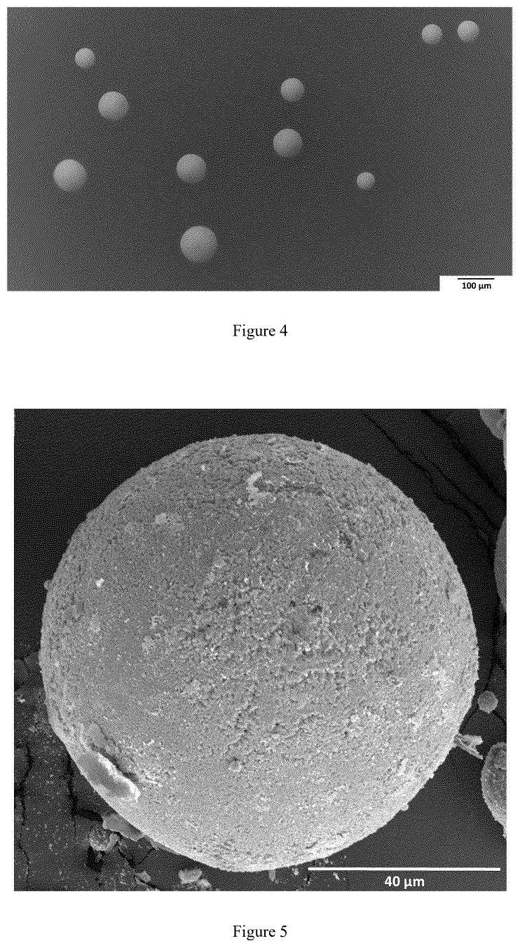

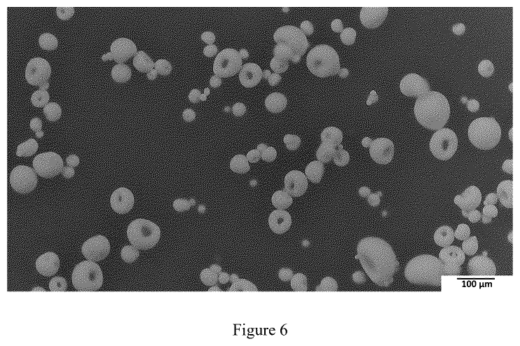

Please refer to FIGS. 4 and 5, which are optical microscope (OM) images (200×) and scanning electron microscope (SEM) images (2000×), respectively, of aluminum nitride granulated powder using cyclohexanol as the additive in another embodiment of the present invention. The solid content of the initial slurry for spray drying was 40 wt %, with the weight percentage composition of the slurry being: 35 wt % aluminum nitride (AlN) powder, 5 wt % yttrium oxide (Y₂O₃) powder, and 60 wt % ethyl acetate. Additionally, 1 wt % polyvinyl butyral (PVB) resin, 1 wt % fish oil, and 10 wt % cyclohexanol were added to the slurry, based on the weight of the aluminum nitride powder. The spray drying process parameters were as follows: a feed rate of 4.53 kg/hr, an atomizer rotation speed of 6,000 rpm, an inlet temperature of 95° C., and an outlet temperature of 65° C. From the 200×OM image in FIG. 4 and the 2000×SEM image in FIG. 5, it can be observed that the spray-dried aluminum nitride granulated powder using cyclohexanol as the additive exhibits a complete spherical morphology. The particle size of an individual granule observed in the SEM image is approximately 90 μm.

The actual measurement data of particle size analysis and flow characteristics for aluminum nitride granulated powders prepared with ethylene glycol and cyclohexanol as additives in the embodiments of this invention are shown in Table 1. The aluminum nitride granulated powder using ethylene glycol as the additive has an average particle size D₅₀ of 65.6 μm, a bulk density of 0.96 g/cm³, and an angle of repose of 29°. The aluminum nitride granulated powder using cyclohexanol as the additive has an average particle size D₅₀ of 82.6 μm, a bulk density of 1.07 g/cm³, and an angle of repose of 26°. The measured specifications for commercially available aluminum nitride granulated powder are as follows: average particle size D₅₀ of 78 μm, bulk density of 0.99 g/cm³, and an angle of repose of 28°. The particle size distribution and flow characteristic data of the spherical aluminum nitride granulated powders prepared by the method of this invention are comparable to those of commercially available aluminum nitride granulated powders. This demonstrates that the aluminum nitride granulated powders prepared by the method of this invention possess excellent spherical morphology and superior flowability.

Table 1: Actual Measurement Data of Particle Size Analysis and Flow Characteristics of Aluminum Nitride Granulated Powders with Ethylene Glycol and Cyclohexanol as Additives

| Example No. | | | Example 1 | Example 2 |
|---|---|---|---|---|
| Slurry for | Solid Content | | 42 wt % | 40 wt % |
| Spray | Binder | | 1 wt % PVB | 1 wt % PVB |
| Drying | Dispersant | | 1 wt % Fish oil | 1 wt % Fish oil |
| | Additive | | 4 wt % Ethylene | 10 wt % |
| | | | glycol | Cyclohexanol |
| Spray | Feed Rate (kg/hr) | | 4.7 | 4.53 |
| Drying | Atomizer RPM | | 6,500 | 6,000 |
| Parameters | Inlet Temp. (° C.) | | 95 | 95 |
| | Outlet Temp. (° C.) | | 70 | 65 |
| Charac- | Bulk Density (g/cm³) | | 0.96 | 1.07 |
| teristics of | Angle of Repose (°) | | 29 | 26 |
| Granule | Particle | D₁₀ (μm) | 35.3 | 56.2 |
| | Size Dis- | D₅₀ (μm) | 65.6 | 82.6 |
| | tribution | D₉₀ (μm) | 84.4 | 104 |

To maximize the efficiency of spray drying equipment and enhance production capacity, the solid content of the slurry must be increased as much as possible to shorten the spray drying time and thereby improve the yield of granulated powders. However, higher solid content increases the viscosity of the slurry. Excessive viscosity is unfavorable for the spray granulation process, as shown in FIG. 6, where numerous ellipsoidal granules are produced, often exhibiting hollow or indented spherical morphologies. Conversely, when the solvent content is too high, the slurry viscosity becomes too low, making it difficult for the atomized droplets to dry and form properly. This results in granulated powders with higher moisture content, which promotes powder agglomeration and reduces the yield of the granulated powders.

Therefore, this invention optimizes the slurry formulation and solid content ratio to achieve an appropriate viscosity. Additionally, organic alcohols with high surface tension are added, and spray drying parameters, such as feed rate, atomizer rotational speed, inlet temperature, and outlet temperature, are precisely controlled. This approach ensures the resulting aluminum nitride granulated powders have a desirable average particle size distribution, excellent spherical morphology, and high flowability.

In summary, the present invention provides a method for preparing spherical aluminum nitride powders with high flowability. Through the design of the slurry's solid content ratio and formulation, the solid-to-liquid ratio is optimized to ensure the mixed slurry achieves an appropriate viscosity. By precisely controlling the rotational speed of the atomizer's disc and the feed rate, the slurry is atomized in the spray dryer to produce droplets with diameters meeting the required specifications. Furthermore, appropriate inlet and outlet temperatures of the drying tower are set to ensure the droplets dry uniformly from the outside to the inside, forming regular spherical granules. This results in spherical aluminum nitride powders with a suitable average particle size distribution and excellent flowability.

Additionally, the addition of organic alcohols with high surface tension enhances the sphericity and flowability of the final granulated powders. This improvement contributes to the efficiency and performance of subsequent processes, such as dry pressing and high-temperature sintering, for fabricating aluminum nitride ceramic bulk materials with superior yield and overall properties.

The above embodiments are merely illustrative of the features and effects of the present invention and are not intended to limit the substantial technical content of the invention. Any person skilled in the art may modify and make variations to the above embodiments without departing from the spirit and scope of the invention. Therefore, the scope of protection of the present invention should be as defined in the following claims of the patent application.

What is claimed is:

1. A method for preparing spherical aluminum nitride powder with high flowability, comprising the steps of:
(A) providing aluminum nitride powder, a sintering aid, a dispersant, and a solvent, and mixing them through a first wet ball milling process according to a first fixed weight ratio to obtain a mixture;
(B) providing a binder and an organic alcohol-based additive, and adding them to the mixture obtained in step (A) according to a second fixed weight ratio, followed by a second wet ball milling process to form a mixed slurry;
(C) atomizing the mixed slurry into droplets;
(D) drying the atomized mixed slurry to obtain dried spherical aluminum nitride granules; and
(E) collecting the dried spherical aluminum nitride granules to obtain spherical aluminum nitride powder with high flowability, characterized by an average particle size distribution D₅₀ of 60-90 μm, a bulk density of 0.8-1.1 g/cm³, and an angle of repose of less than 30°.

2. The method of claim 1, wherein
the aluminum nitride powder in step (A) has a purity of over 99%, an oxygen content of <1.0 wt %, and an average particle size of 1-5 μm;
the sintering aid is a rare earth metal compound, or an alkaline earth metal compound, which is selected from one of yttrium oxide, yttrium fluoride, magnesium oxide, calcium oxide, and calcium fluoride;
the dispersant is selected from one of citric acid, fish oil, polyethyleneimine, triethyl phosphate, polyacrylic acid, and sodium stearate; and
the solvent is an organic solvent selected from one of anhydrous ethanol, methanol, isopropanol, ethyl acetate, methyl ethyl ketone, and n-butanol.

3. The method of claim 1, wherein the first fixed weight ratio in step (A) is 29-45 wt % of the aluminum nitride powder, 1-5 wt % of the sintering aid, and 50-70 wt % of the solvent, with 0.1-3 wt % of the dispersant calculated based on the weight of the aluminum nitride powder.

4. The method of claim 1, wherein
the binder in step (B) is selected from the group consisting of polyvinyl butyral resin, acrylic resin, and phenolic resin; and
the additive is an organic alcohol selected from the group consisting of ethylene glycol, cyclopentanol, and cyclohexanol.

5. The method of claim 1, wherein the second fixed weight ratio in step (B) is 1-10 wt % of the binder and 3-20 wt % of the additive, calculated based on the weight of the aluminum nitride powder.

6. The method of claim 1, wherein the viscosity of the mixed slurry in step (B) is 100-3000 cP.

7. The method of claim 1, wherein steps (C) to (E) are performed using a centrifugal spray drying apparatus, and the centrifugal spray drying apparatus comprises a feeding unit, an atomizer disc, a drying tower, and a collection bucket.
